(19) United States
(12) Patent Application Publication
(10) Pub. No.: US 2007/0048567 A1
(43) Pub. Date: Mar. 1, 2007

(54) Fuel cell unit and method of correcting measurement value

(75) Inventors: Taishi Hisano, Ome-shi (JP); Akihiro Ozeki, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Kabushiki Kaisha Toshiba

(21) Appl. No.: 11/509,483

(22) Filed: Aug. 23, 2006

(30) Foreign Application Priority Data
Aug. 31, 2005 (JP) 2005-252372

(51) Int. Cl. H01M 8/04

(52) U.S. Cl. 429/22; 429/13

(57) ABSTRACT

According to one embodiment, there is provided a fuel cell unit capable of generating power by a fuel cell. The fuel cell unit includes a concentration measuring section to measure a concentration of a fuel solution for use in power generation by the fuel cell, a storage section to store a first concentration measurement value obtained from the concentration measuring section when power generation by the fuel cell terminates, and a control section to correct a second concentration measurement value obtained from the concentration measuring section when power generation by the fuel cell starts, if there is a difference of a certain amount or more between the first concentration measurement value stored in the storage section and the second concentration measurement value obtained from the concentration measuring section, to keep the difference under the certain amount.

### CROSS-REFERENCE TO RELATED APPLICATIONS

This application is based upon and claims the benefit of priority from Japanese Patent Application No. 2005-252372, filed Aug. 31, 2005, the entire contents of which are incorporated herein by reference.

### BACKGROUND

1. Field

One embodiment of the invention relates to a fuel cell unit of, for example, direct methanol type, and a method of correcting a measurement value.

2. Description of the Related Art

There are various types of fuel cell. A direct methanol fuel cell (DMFC) is known as suitable for an information processing apparatus. This type of fuel cell employs a dilution circulating system, in which a methanol solution of a low concentration is circulated. Consumption of methanol by power generation is compensated for by supplying high-concentration methanol to the fuel cell. Consumption of water is compensated for by collecting water generated by a chemical reaction in the fuel cell and returning it to the fuel cell. For this purpose, the system has a mixing tank for producing a methanol solution by mixing the high-concentration methanol and water.

To continuously generate power satisfactorily, it is necessary to maintain the methanol concentration in the methanol solution supplied to the DMFC cell to fall within a predetermined range. A concentration sensor is used to detect the methanol concentration. In general, the concentration sensor is arranged in a fuel supply path through which the methanol solution is supplied from the mixing tank to a DMFC, or a path through which the methanol solution is returned to the mixing tank via a branch from the fuel supply path.

An ultrasonic concentration sensor is commonly employed as a concentration sensor to be arranged in a fuel supply path. The ultrasonic concentration sensor utilizes the characteristic that a sonic speed of a pulse passing through a liquid varies depending on the concentration and temperature of the liquid. Jpn. Pat. Appln. KOKAI Publication No. 2004-95376 discloses a conventional art, in which a temperature sensor is mounted near a concentration sensor that measures a methanol concentration to compensate for a change in methanol concentration due to a change in temperature conditions.

In the temperature sensor described above, the hygroscopic condition of a member constituting the sensor may change or the member may be deformed with time in a period from the time when the power generating operation of the fuel cell is stopped to the time when the fuel cell is activated next. Accordingly, the propagation distance of an ultrasonic pulse may vary, and the concentration measurement value may be abnormal at the time of activating the fuel cell. In that case, it will be difficult to correctly control the methanol concentration in a methanol solution within a predetermined range.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary external view showing a fuel cell unit according to an embodiment of the present invention;

FIG. 2 is an exemplary external view showing a state in which an information processing apparatus is connected to the fuel cell unit;

FIG. 3 is an exemplary system diagram mainly showing a configuration of a power generating portion of the fuel cell unit;

FIG. 4 is an exemplary system diagram showing the state in which the information processing apparatus is connected to the fuel cell unit;

FIG. 5 is an exemplary system diagram showing configurations of the fuel cell unit and the information processing apparatus;

FIG. 6 is an exemplary diagram showing transition of states of the fuel cell unit and the information processing apparatus;

FIG. 7 is an exemplary diagram showing main control commands issued to the fuel cell unit;

FIG. 8 is an exemplary diagram showing main power supply information of the fuel cell unit;

FIG. 9 is an exemplary diagram for explaining a configuration of the temperature sensor shown in FIG. 3;

FIG. 10 is an exemplary graph showing the correlation between a temperature of a methanol solution and a detection value of the concentration sensor;

FIG. 11 is an exemplary block diagram showing a functional configuration of the fuel cell control section shown in FIG. 3;

FIG. 12 is an exemplary diagram explaining that whether to perform correction processing is determined in accordance with a difference in concentration measurement value; and

FIG. 13 is an exemplary flowchart showing operations executed in the temperature sensor and the fuel cell control section shown in FIG. 11.

### DETAILED DESCRIPTION

Various embodiments according to the invention will be described hereinafter with reference to the accompanying drawings. In general, according to one embodiment of the invention, there is provided a fuel cell unit capable of generating power by a fuel cell. The fuel cell unit includes a concentration measuring section to measure a concentration of a fuel solution for use in power generation by the fuel cell, a storage section to store a first concentration measurement value obtained from the concentration measuring section when power generation by the fuel cell terminates, and a control section to correct a second concentration measurement value obtained from the concentration measuring section when power generation by the fuel cell starts, if there is a difference of a certain amount or more between the first concentration measurement value stored in the storage section and the second concentration measurement value obtained from the concentration measuring section, to keep the difference under the certain amount.

FIG. 1 is an external view showing a fuel cell unit according to an embodiment of the present invention. As shown in FIG. 1, the fuel cell unit 10 includes a mount portion 11 and a fuel cell unit body 12. On the mount portion 11, a rear portion of an information processing apparatus, such as a notebook computer, is to be mounted. The fuel cell unit body 12 incorporates a DMFC stack, which generates power by an electrochemical reaction, and auxiliary mechanism (a pump, a valve, etc.) to inject and circulate methanol (fuel) and air in the DMFC stack.

The fuel cell unit body 12 has a unit case 12a and a cover 12b. The unit case 12a incorporates a detachable fuel cartridge (not shown) in, for example, a left side end portion. The cover 12b is removable so that the fuel cartridge can be exchanged for another one.

An information processing apparatus is mounted on the mount portion 11. A docking connector 14, which serves as a connecting portion to connect with the information processing apparatus, is provided on the upper surface of the mount portion 11. On the other hand, a docking connector 21 (represented by broken lines), which serves as a connecting portion to connect with the fuel cell unit 10, is provided on, for example, a rear portion of the bottom surface of the information processing apparatus. The docking connector 21 is mechanically and electrically connected to the docking connector 14 of the fuel cell unit 10. Three positioning projections 15 and three hooks 16 are formed on the mount portion 11. They are inserted in three corresponding holes in the rear portion of the bottom surface of the information processing apparatus.

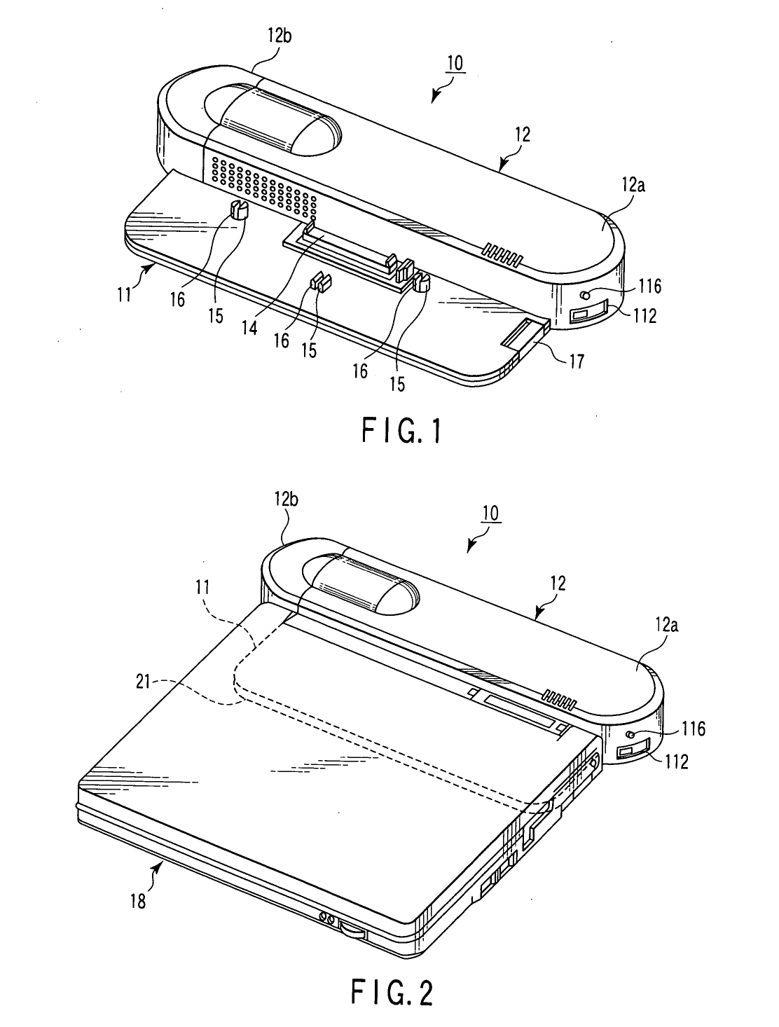

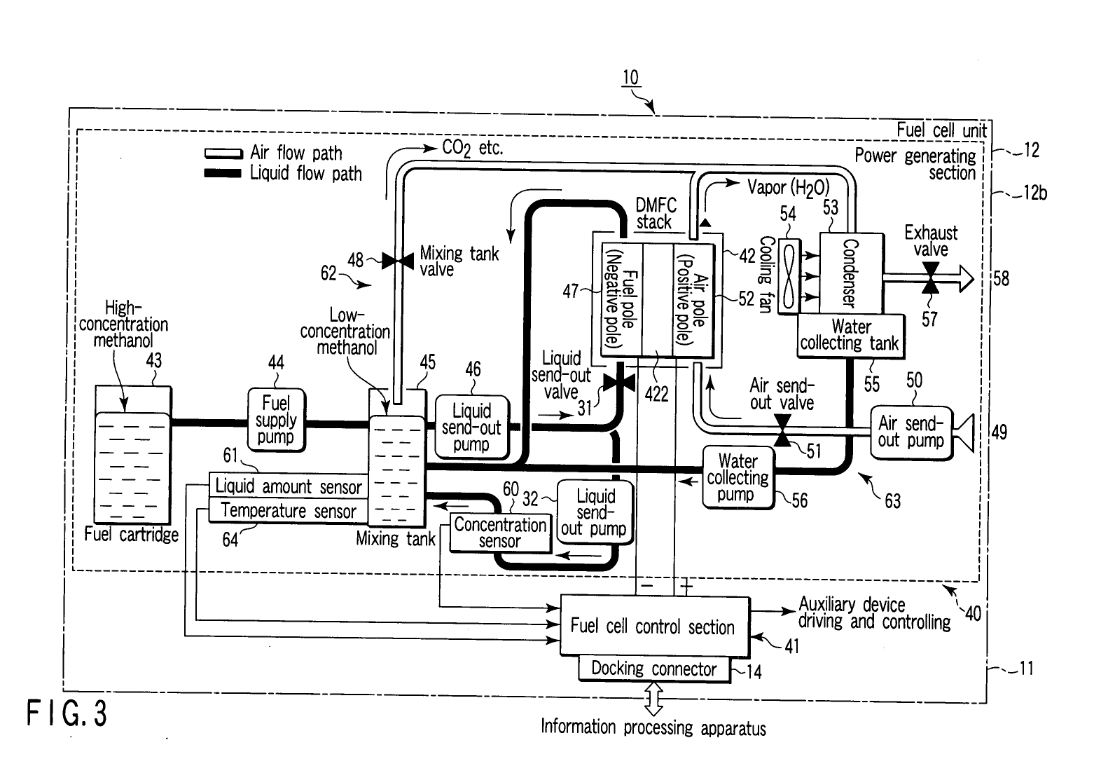

To remove the information processing apparatus from the fuel cell unit 10, an eject button 17 of the fuel cell unit 10 shown in FIG. 2 is pushed. As a result, a lock mechanism (not shown) is released and the information processing apparatus can be easily removed from the fuel cell unit 10.

A power generation setting switch 112 and a fuel cell operation switch 116 are provided on, for example, a right side surface of the fuel cell unit body 12.

The power generation setting switch 112 is formed of, for example, a slide switch, which allows the user to preset permission or prohibition of power generation by the fuel cell unit 10.

The fuel cell operation switch 116 is used, for example, in a case where the information processing apparatus 18 is operated by the power generated by the fuel cell unit 10, and the information processing apparatus 18 is to continue operating, whereas power generation of the fuel cell unit 10 is stopped. In this case, the information processing apparatus 18 continues operating by using power of a secondary battery incorporated therein. The fuel cell operation switch 116 is formed of, for example, a push switch.

FIG. 2 is an external view showing a state in which the information processing apparatus 18 (for example, the notebook computer) is mounted on and connected to the mount portion 11 of the fuel cell unit 10.

The shape and size of the fuel cell unit 10 and the shape and position of the docking connector 14, shown in FIGS. 1 and 2, are mere examples, and may be of variously modified.

FIG. 3 is a system diagram of the fuel cell unit 10, showing in particular detailed systems of the DMFC stack and the auxiliary mechanism provided around it.

The fuel cell unit 10 includes a power generating section 40, and a fuel cell control section 41, which is a control section of the fuel cell unit 10. The fuel cell control section 41 not only controls the power generating section 40 but also functions as a communication control section to perform communication with the information processing apparatus 18.

The power generating section 40 includes the DMFC stack 42, which is a center of power generation. It also includes a fuel cartridge 43 containing methanol, i.e., fuel. Methanol of a high concentration is sealed within the fuel cartridge 43. The fuel cartridge 43 is removably attached to the power generating section 40, so that it can be easily exchanged with a new one when the fuel is consumed.

Generally, in a direct methanol type-fuel cell, a crossover phenomenon must be reduced to improve the power generation efficiency. For this purpose, it is effective to dilute high-concentration methanol, and inject the obtained low-concentration methanol into a fuel pole 47. The fuel cell unit 10 employs a dilution circulating system 62; that is, auxiliary mechanism 63 necessary to realize the dilution circulating system 62 is provided in the power generating section 40.

The auxiliary mechanism 63 is provided in a liquid flow path and an air flow path.

In the liquid flow path, an output portion of the fuel cell cartridge 43 is connected to a fuel supply pump 44 and an output portion of the fuel supply pump 44 is connected to a mixing tank 45. An output portion of the mixing tank 45 is connected to a liquid send-out pump 46, and an output portion of the liquid send-out pump 46 is connected to the fuel pole 47 of the DMFC stack 42 via a liquid send-out valve 31. Further, an output portion of the fuel pole 47 is connected to the mixing tank 45. This liquid flow path for flowing the liquid back to the mixing tank 45 by means of the power of the liquid send-out pump 46 is called “a first liquid flow path”. The liquid send-out pump 46 may be provided on the output side of the fuel pole 47, instead of the input side of the fuel pole 47. The liquid send-out valve 31 is not essentially required.

An output portion of a water collecting tank 55 is connected to a water collecting pump 56. An output portion of the water collecting pump 56 is connected to the mixing tank 45.

In the first liquid flow path described above, a branch is formed between the liquid send-out pump 46 and the fuel pole 47. Another flow path (a pipe or the like), which causes the methanol solution to flow back to the mixing tank 45, extends from the branch. This flow path is called “a second liquid flow path”. The second liquid flow path is a path dedicated to detection of the methanol concentration in the methanol solution. A liquid send-out pump 32 is provided in the second liquid flow path. An output portion of the liquid send-out pump 32 is connected to the mixing tank 45 via a concentration sensor 60. The liquid send-out pump 32 is not indispensable.

The concentration sensor 60 is provided in a portion of the flow path at which the methanol solution flowing from the first liquid flow path to the second liquid flow path (at 60° C. or higher) is cooled to, for example, 40° C. or lower. Thus, the concentration sensor 60 is protected against an adverse influence by the heat.

The concentration sensor 60 requires a very small amount of methanol solution (a negligible amount relative to all methanol solution used in the power generating section 40) to detect the concentration. The inner diameter of the second liquid flow path is much smaller than that of the first liquid flow path; that is, the amount of methanol solution flowing in the second liquid flow path is very small. Thus, the fuel supply to the DMFC stack 42 is not adversely influenced.

On the other hand, in the air flow path, an air send-out pump 50 is connected to an air pole 52 of the DMFC stack 42 via an air send-out valve 51. An output portion of the air pole 52 is connected to a condenser 53. The mixing tank 45 is also connected to the condenser 53 via a mixing tank valve 48. The condenser 53 is connected to an exhaust port 58 via an exhaust valve 57. The condenser 53 has a fin, which effectively condenses vapor. A cooling fan 54 is arranged near the condenser 53.

Power generation mechanism of the power generating section 40 of the fuel cell unit 10 will now be described with reference to the flow of the fuel and air (oxygen).

First, the high-concentration methanol in the fuel cartridge flows into the mixing tank 45 by means of the fuel supply pump 44. In the mixing tank 45, the high-concentration methanol is mixed with the collected water and the low-concentration methanol (which has been left after the power generating reaction) supplied form the fuel pole 47. Thus, the high-concentration methanol is diluted into a low-concentration methanol. The low-concentration methanol is kept to a concentration (for example, 3 to 6%), which provides a high power generating efficiency. The concentration is controlled by the fuel cell control section 41, which controls the amount of the high-concentration methanol supplied to the mixing tank 45 via the fuel supply pump 44, based on, for example, the detection results of the concentration sensor 60. Alternatively, the concentration may be controlled by the water collecting pump 56, which controls the amount of water flowing back to the mixing tank 45.

The mixing tank 45 is provided with a liquid amount sensor 61, which detects the amount of the methanol solution in the mixing tank 45, and a temperature sensor 64, which detects the temperature. The detection results are supplied to the fuel cell control section 41 and used to control the power generating section 40 or the like.

The methanol solution diluted in the mixing tank 45 is pressurized by the liquid send-out pump 46, and injected into the fuel pole (negative pole) 47 of the DMFC stack 42. In the fuel pole 47, methanol is oxidized, with the result that electrons are generated. Hydrogen ions (H⁺) generated by the oxidization pass through a solid polymer electrolytic film 422 in the DMFC stack 42 and reach the air pole (positive pole) 52.

Carbon dioxide generated by the oxidization in the fuel pole 47 flows back to the mixing tank 45 together with the methanol solution that has not been used in the oxidization. Carbon dioxide evaporates in the mixing tank 45, flows to the condenser 53 via the mixing tank valve 48, and finally discharges out through the exhaust port 58 via the exhaust valve 57.

On the other hand, air (oxygen) is taken in the system through an intake port 49, pressurized by the air send-out pump 50, and injected into the air pole (positive pole 52) via the air send-out valve 51. In the air pole 52, the reduction of oxygen (O₂) progresses, so that water (H₂O) as vapor is generated from oxygen (O₂), electrons (e⁻) supplied from an external load and hydrogen ions (H⁺) supplied from the fuel pole 47. The vapor is discharged out of the air pole 52, and enters the condenser 53. In the condenser 53, the vapor is cooled by the cooling fan 54 and condensed into water (liquid), which is temporarily stored in the water collecting tank 55. The collected water flows back to the mixing tank 45 by means of the water collecting pump 56. Thus, the dilution circulating system 62 to dilute the high-concentration methanol is constructed.

As can be understood from the power generating mechanism of the fuel cell unit 10 utilizing the dilution circulating system 62, the auxiliary mechanism 63, such as the pumps 44, 46, 50 and 56, the valves 48, 51 and 57 or the cooling fan 54, is driven in order to obtain power from the DMFC stack, i.e., to start power generation. As a result, the methanol solution and air (oxygen) are injected into the DMFC stack 42, and the electrochemical reaction progresses therein, thereby generating power. To stop power generation, drive of the auxiliary mechanism 63 is stopped.

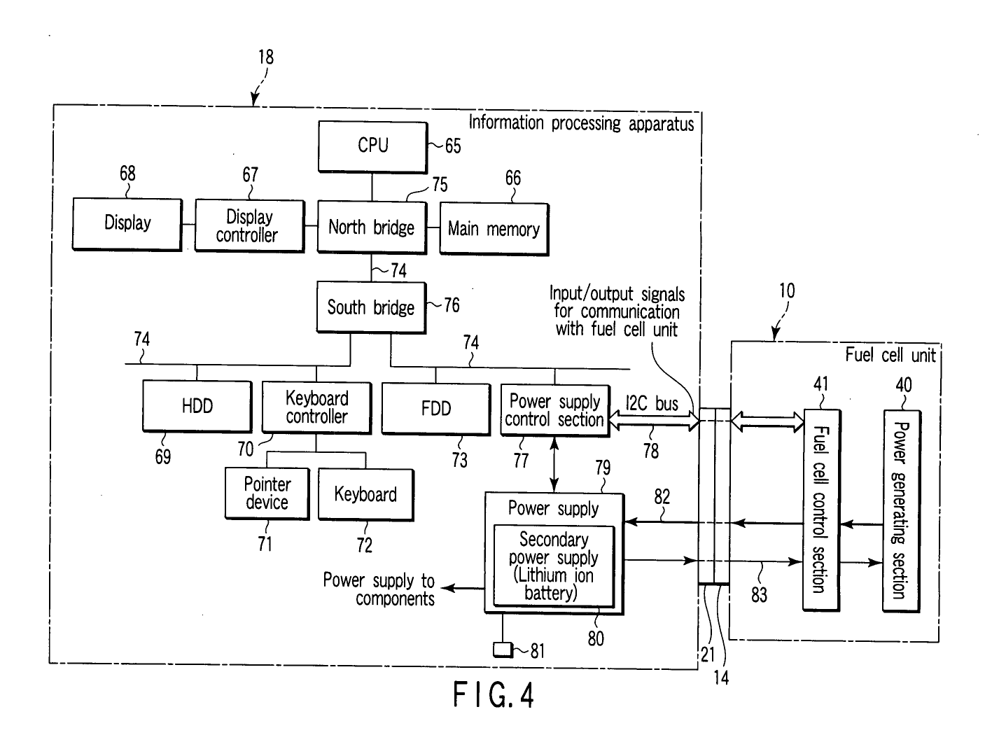

FIG. 4 shows a system configuration of the information processing apparatus 18, to which the fuel cell unit 10 according to the present invention is connected.

The information processing apparatus 18 includes a CPU 65, a main memory 66, a display controller 67, a display 68, a hard disk drive (HDD) 69, a keyboard controller 70, a pointer device 71, a keyboard 72, an FDD 73, a bus 74 which transmits signals between these components, and devices called a north bridge 75 and a south bridge 76 to convert signals transmitted through the bus 74. The information processing apparatus 18 includes a power supply 79, which contains a secondary power supply 80, such as a lithium ion battery. The power supply 79 is controlled by a control section 77 (hereinafter referred to as the power supply control section 77).

A control system interface and a power supply system interface are provided as an electric interface between the fuel cell unit 10 and the information processing apparatus 18. The control system interface is provided to perform communications between the power supply control section 77 of the information processing apparatus 18 and the control section 41 of the fuel cell unit 10. Communications between the information processing apparatus 18 and the fuel cell unit 10 via the control system interface are performed through a serial bus, such as an I2C bus 78.

The power supply system interface is provided to supply power between the fuel cell unit 10 and the information processing apparatus 18. For example, the power generated by the DMFC stack 42 of the power generating section 40 is supplied to the information processing apparatus 18 via the control section 41 (hereinafter referred to as the fuel cell control section 41) and the docking connectors 14 and 21. Further, the power supply system interface includes power supply 83 from the power supply 79 of the information processing apparatus 18 to the auxiliary mechanism 63 etc. of the fuel cell unit 10.

Direct current power, which has been AC/DC converted via an AC adapter connector 81, is supplied to the power supply 79 of the information processing apparatus 18. The information processing apparatus 18 can be operated and the secondary power supply (lithium ion battery) 80 can be charged by this power supply.

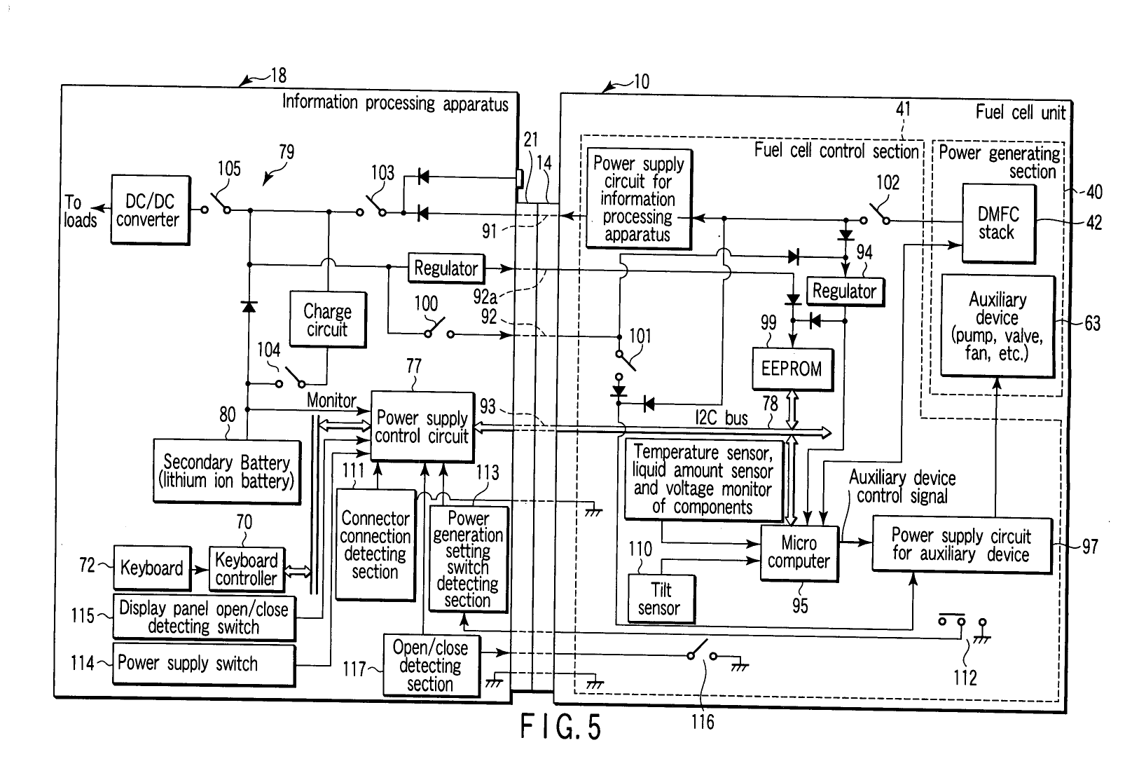

FIG. 5 is a block diagram showing interconnection between the fuel cell control section 41 of the furl cell unit 10 and the power supply 79 of the information processing apparatus 18.

The fuel cell unit 10 and the information processing apparatus 18 are mechanically and electrically connected to each other via the docking connectors 14 and 21. The docking connectors 14 and 20 have a first power supply terminal (output power supply terminal) 91 to supply power generated by the DMFC stack 42 of the fuel cell unit 10 to the information processing apparatus 18, and a second power supply terminal (input power supply terminal for the auxiliary mechanism) 92 to supply power from the information processing apparatus 18 to a microcomputer 95 of the fuel cell unit 10 via a regulator 94 and also to supply power to the power supply circuit 97 for the auxiliary mechanism 63 via a switch 101. They also have a third power supply terminal 92a to supply power from the information processing apparatus 18 to an EEPROM 99.

Further, the docking connectors 14 and 21 have a communication input/output terminal 93 to perform communications between the power supply control section 77 of the information processing apparatus 18 and the microcomputer 95 of the fuel cell unit 10 or the programmable non-volatile memory (EEPROM) 99.

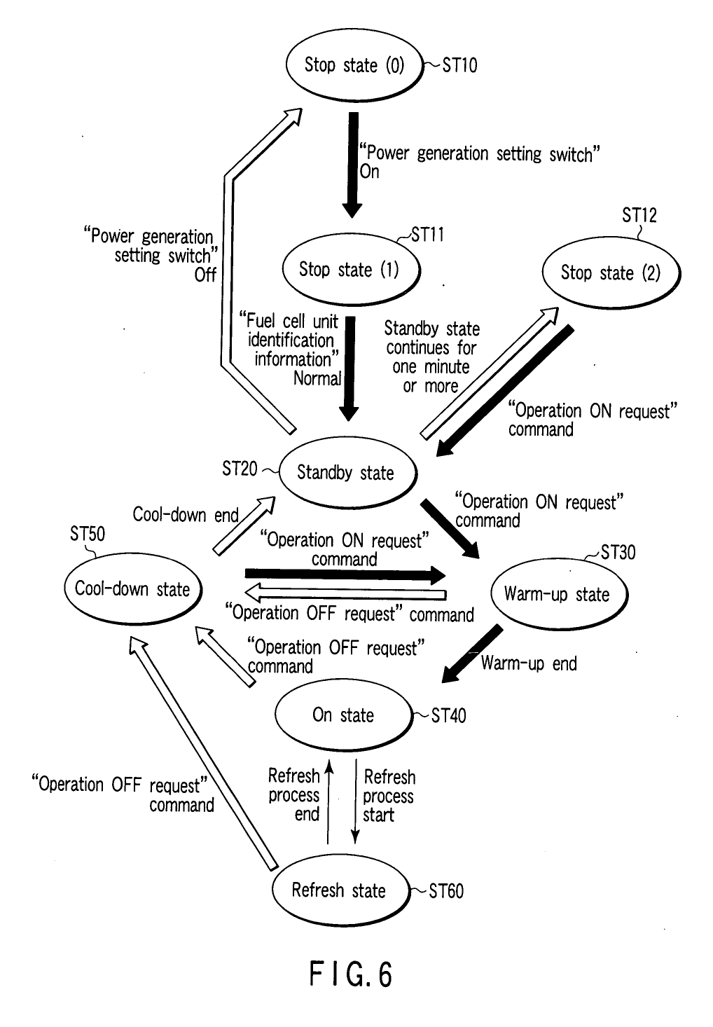

A flow of a basic process for supplying power from the DMFC stack 42 in the fuel cell unit 10 to the information processing apparatus 18 will now be described with reference to the interconnection diagram of FIG. 5 and a diagram showing transition of states of the fuel cell unit 10 of FIG. 6.

It is assumed that the secondary battery (lithium ion battery) 80 of the information processing apparatus is charged with a predetermined power and all switches shown in FIG. 5 are open.

First, the information processing apparatus 18 recognizes that the information processing apparatus 18 and the fuel cell unit 10 are mechanically and electrically connected according to a signal output from a connector connection detecting section 111. This recognition is performed by means of detecting, for example, that the connector connection detecting section 111 is grounded in the fuel cell unit 10 by the connection of the docking connectors 14 and 21 based on the signal input to the connector connection detecting section 111.

The power supply control section 77 of the information processing apparatus 18 recognizes whether the power generation setting switch 112 of the fuel cell unit 10 is set to power generation permission position or power generation prohibition position. For example, a power generation setting switch detecting section 113 detects whether the power generation setting switch 112 is grounded or open. If the power generation setting switch 112 is detected to be open, the power supply control section 77 recognizes that the switch 112 is set to the power generation prohibition position.

The state where the power generation setting switch 12 is set to the power generation prohibition position corresponds to a “stop state (0)” ST10 in the state transition diagram of FIG. 6.

When the information processing apparatus 18 and the fuel cell unit 10 are mechanically connected by the docking connectors 14 and 21, power is supplied from the information processing apparatus 18 to the non-volatile memory (EEPROM) 99, i.e., a memory portion of the fuel cell control section 41, through the third power supply terminal 92a. The EEPROM 99 prestores identification information of the fuel cell unit 10 etc. The identification information may include in advance, for example, a part code, a manufacturing serial number or a nominal output of the fuel cell unit. The EEPROM 99 is connected to a serial bus, such as an I2C bus 78, so that the data stored in the EEPROM 99 can be read out as far as the power is supplied to the EEPROM 99. In the structure shown in FIG. 5, the power supply control section 77 can read information from the EEPROM 99 via the communication input/output terminal 93.

In this state, the fuel cell unit 10 does not generate power, and power has not been supplied to any components other than the EEPROM 99.

If the user changes the setting of the power generation setting switch 112 to power generation permission position (referring to FIG. 5, the power generation setting switch 112 is grounded), the power supply control section 77 in the information processing apparatus 18 can read identification information from the EEPROM 99 in the fuel cell unit 10. This state corresponds to a “stop state (1)” ST11 in FIG. 6.

In other words, unless the user changes the setting of the power generation setting switch 112 to the power generation permission position, that is, as long as the power generation setting switch 112 is set to the power generation prohibition position, the “stop state (0)” ST10 is maintained. Thus, the power generation in the fuel cell unit 10 can be prohibited.

It is preferable that the power generation setting switch be a slide switch or the like, which keeps either the open or closed state of the switch.

Reading of identification information by the power supply control section 77 is performed by means of reading the identification information of the fuel cell unit 10 from the EEPROM 99 in the fuel cell unit 10 via the serial bus, such as the I2C bus 78.

If it is determined that the fuel cell unit 10 connected to the information processing apparatus 18 is adapted for the information processing apparatus 18 based on the identification information read by the power supply control section 77, the “stop state (1)” ST11 in FIG. 6 transitions to a “standby state” ST20.

More specifically, the power supply control section 77 in the information processing apparatus 18 closes the switch 100 in the information processing apparatus 18, thereby supplying the power from the secondary battery 80 to the fuel cell unit 10 via the first power supply terminal 92. The power is supplied to the microcomputer 95 via the regulator 94.

In the “standby state” ST20, the switch 101 in the fuel cell unit 10 is open and no power is supplied to the power supply circuit 97 for the auxiliary mechanism 63. Therefore, in this state, the auxiliary mechanism 63 does not operate.

However, the microcomputer 95 starts operating, and is ready to receive various control commands from the power supply control section 77 in the information processing apparatus 18 through the I2C bus 78. The microcomputer 95 is also ready to send power supply information of the fuel cell unit 10 to the information processing apparatus 18 through the I2C bus.

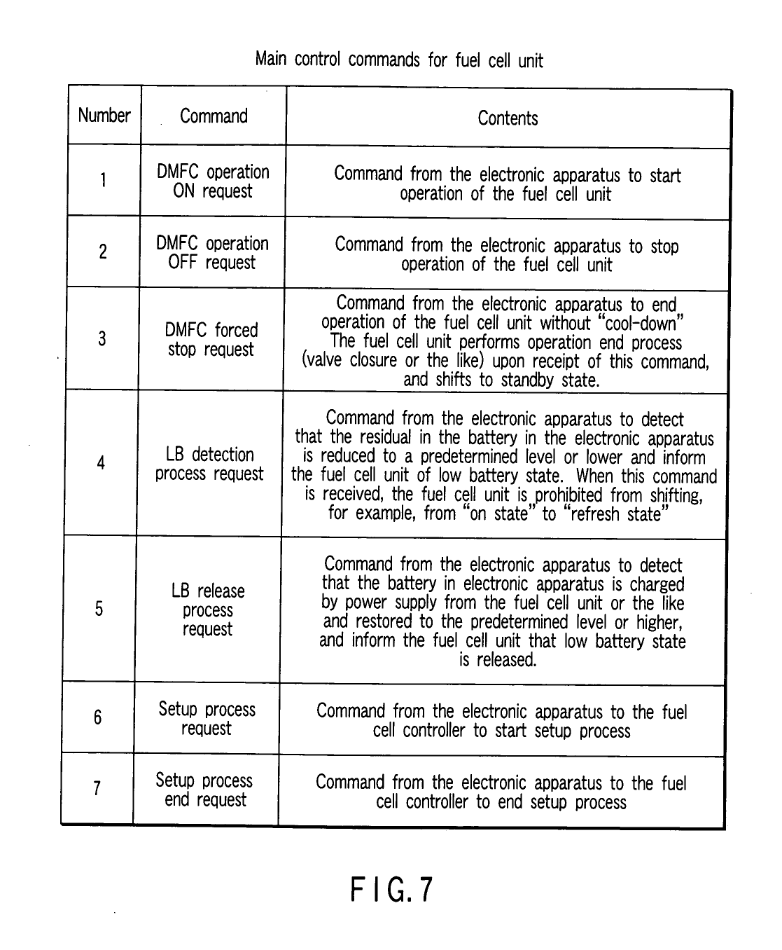

FIG. 7 shows examples of control commands sent from the power supply control section 77 in the information processing apparatus 18 to the microcomputer 95 in the fuel cell control section 41.

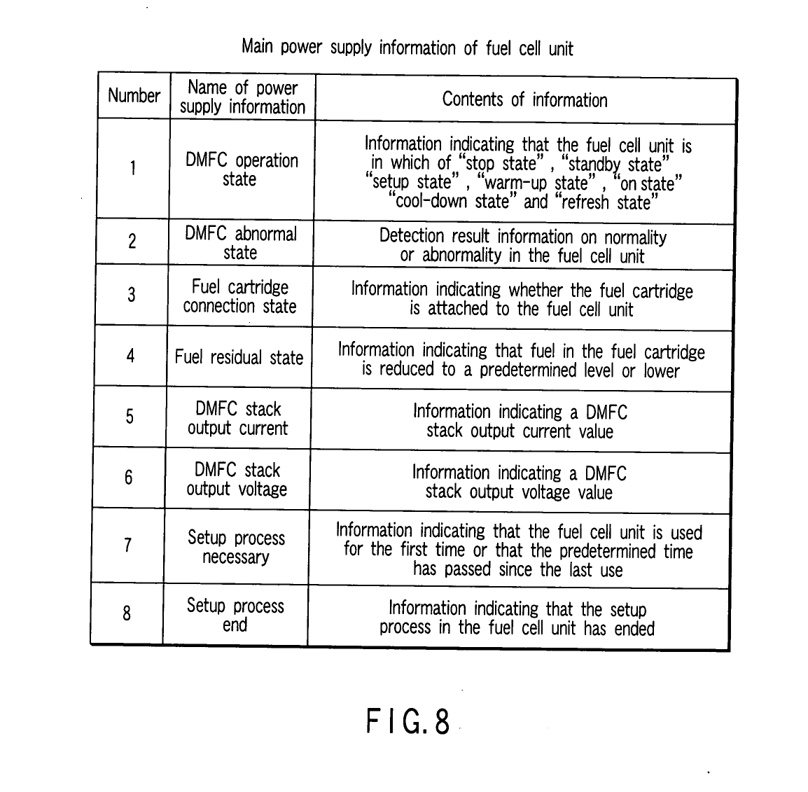

FIG. 8 shows examples of power supply information sent from the microcomputer 95 in the fuel cell control section 41 to the power supply control section 77 in the information processing apparatus 18.

The power supply control section 77 in the information processing apparatus 18 reads “DMFC operation state” (Number 1 in FIG. 8) from the power supply information shown in FIG. 8, thereby recognizing that the fuel cell unit 10 is in the “standby state” ST20.

In the “standby state” ST20, when the power supply control section 77 sends a “DMFC operation ON request” command (power generation start command) of the control commands shown in FIG. 7 to the fuel cell control section 41, the fuel cell control section 41 shifts the state of the fuel cell unit 10 to a “warm-up state” ST30 upon receipt of the command.

More specifically, the switch 101 in the fuel cell control section 41 is closed under the control of the microcomputer 95, thereby supplying power from the information processing apparatus 18 to the power supply circuit 97 for the auxiliary mechanism 63. Simultaneously, the auxiliary mechanism 63 in the power generating section 40, such as the pumps 44, 46, 50 and 56, the valves 48, 51 and 57 and the cooling fan 54 shown in FIG. 4, is driven in accordance with the auxiliary mechanism control signal sent from the microcomputer 95. Further, the microcomputer 95 closes a switch 102 in the fuel cell control section 41.

As a result, the methanol solution and air are injected into the DMFC stack 42 in the power generating section 40, so that power generation starts. Supply of power generated by the DMFC stack 42 to the information processing apparatus 18 also starts. However, since the generated power does not instantaneously reach the nominal output, the state until the power reaches the nominal output is called the “warm-up state” ST30.

When the microcomputer 95 in the fuel cell control section 41 determines that the output of the DMFC stack 42 reaches the nominal output by, for example, monitoring the output voltage of the DMFC stack 42 and the temperature of the DMFC stack 62, it opens the switch 101 in the fuel cell unit 10, so that the source of the power supplied to the auxiliary mechanism 63 is switched from the information processing apparatus 18 to the DMFC stack 42. This state corresponds to an “on state” ST40.

The above description is a summary of the process from the “stop state” ST10 to the “on state” ST40.

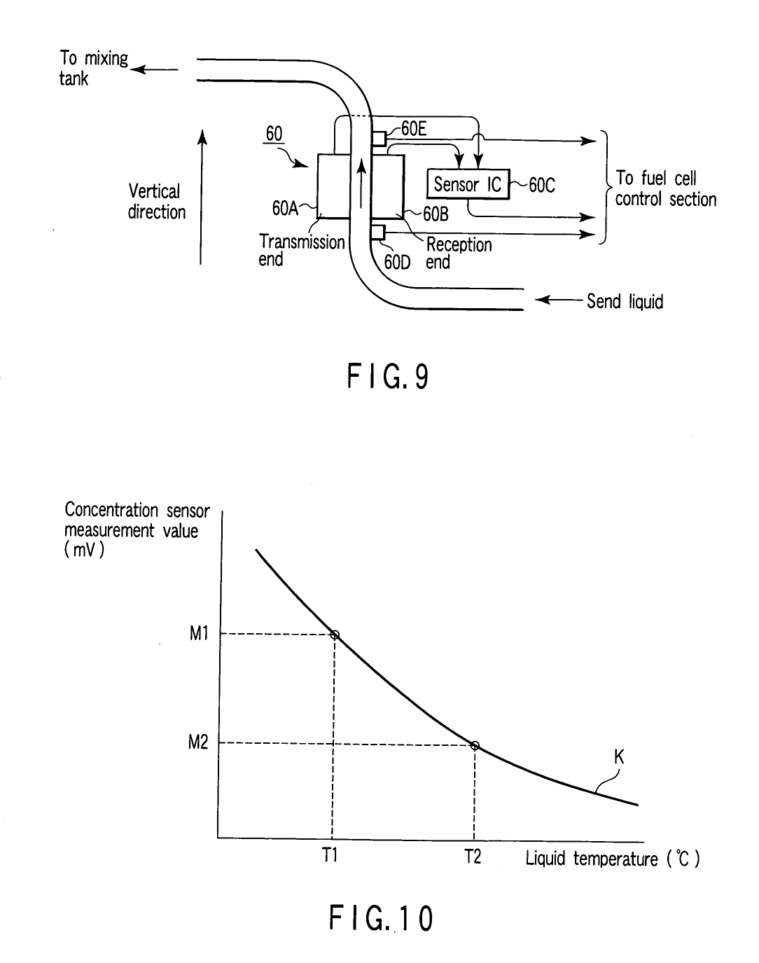

FIG. 9 is a diagram for explaining a configuration of the temperature sensor 60.

The concentration sensor 60 is provided in the second liquid flow path (which causes the methanol solution sent out from the liquid send-out pump 46 to flow back to the mixing tank 45 via the branch of the first liquid flow path). A type of sensor, called an ultrasonic concentration sensor (or a sonic speed sensor), is used as the concentration sensor 60 in this embodiment. The ultrasonic concentration sensor measures a concentration based on a sonic speed and temperature, by utilizing the characteristic that a sonic speed of a pulse passing through a liquid varies depending on the concentration and temperature of the liquid. The concentration sensor is not limited to the sonic speed sensor, but may be any other type of sensor, which can finally measure the methanol concentration.

The concentration sensor 60 has, for example, a transmission end 60A, a reception end 60B, a sensor IC 60C and temperature sensors (or thermistors) 60D and 60E. The aforementioned portion of the flow path is situated between the transmission end 60A and the reception end 60B.

The transmission end 60A periodically transmits a predetermined pulse to the reception end 60B. The reception end 60B receives the pulse transmitted from the transmission end 60A. The sensor IC 60C detects the speed (sonic speed) of the pulse transmitted through the methanol solution at the aforementioned portion of the flow path based on the difference between the timing when the pulse is transmitted from the transmission end 60A and the timing when the pulse is received by the reception end 60B. There is a tendency that the higher the methanol concentration, the lower the sonic speed. The result of detection by the sensor IC 60C is notified to the fuel cell control section 41.

The temperature sensors 60D and 60E detect the temperature of the methanol solution flowing through the aforementioned portion of the flow path. It is known that the methanol concentration in the methanol solution varies depending on the temperature of the methanol solution. Therefore, the temperatures detected by the temperature sensors 60D and 60E are also used to measure the methanol concentration. The results of detections by the temperature sensors 60D and 60E are notified to the fuel cell control section 41. The concentration sensor 60 may be configured such that the results of detections by the temperature sensors 60D and 60E are input to the sensor IC 60C.

The fuel cell control section 41 can measure the methanol concentration in the methanol solution based on the results of the detection by the sensor IC 60C and the temperature sensors 60D and 60E. For example, the fuel cell control section 41 obtains the methanol concentration from the detected sonic speed based on the correlation between the methanol concentration and the sonic speed. Further, the value of the methanol concentration is corrected in accordance with the temperature detected by the temperature sensors 60D and 60E. In this way, the fuel cell control section 41 obtains the value of the methanol concentration in the methanol solution. The fuel cell unit may be configured such that the calculation of the methanol concentration is executed inside the sensor IC 60C in the concentration sensor 60.

FIG. 10 is a graph showing the correlation between a temperature of a methanol solution and a detection value of the concentration sensor.

In the state where the methanol concentration of the methanol solution is maintained properly, the correlation between a detection value of a concentration detected by the sensor IC 60C of the concentration sensor 60 and a detection value of a liquid temperature detected by the temperature sensor 60D or 60E is represented by a curve K shown in FIG. 10. For example, when the liquid temperature is T1 (° C.), the concentration detection value is M1 (mV), and when the liquid temperature is T2 (° C.), the concentration detection value is M2 (mV). If the concentration detection value at a certain liquid temperature is considerably deviated from the curve K, the fuel cell control section 41 controls the auxiliary mechanism, such as the pump, so that the concentration detection value approximates to the curve K. As a result, the methanol concentration of the methanol solution is adjusted.

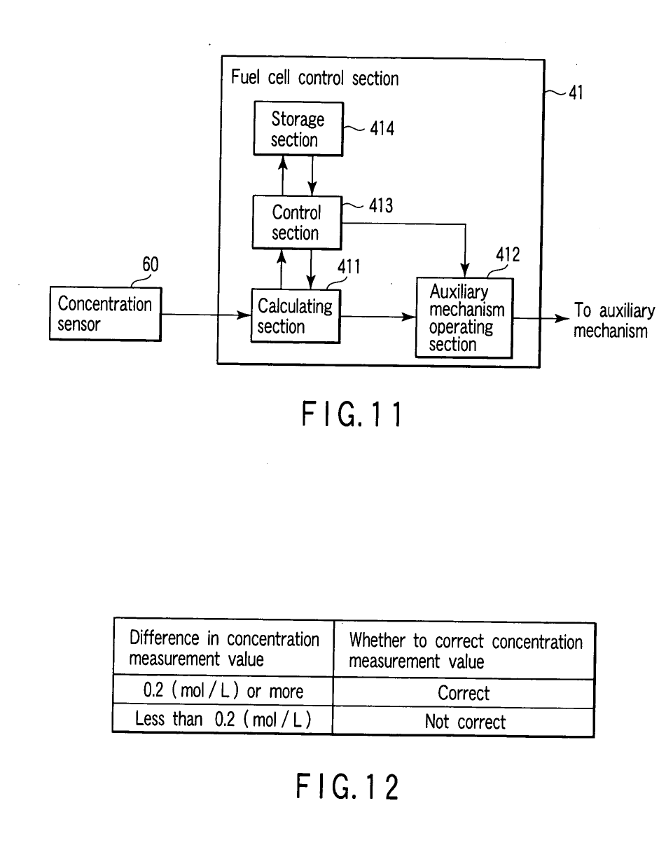

A configuration and operation relating to correction of a concentration measurement value according to the embodiment will now be described with reference to FIGS. 11 to 13.

FIG. 11 is a block diagram showing a functional configuration of the fuel cell control section 41.

The fuel cell control section 41 includes a calculating section 411, an auxiliary mechanism operating section 412, a control section 413 and a storage section 414.

The calculating section 411 calculates a concentration measurement value of the methanol concentration in the methanol solution based on the detection results in the sensor IC 60C and the temperature sensors 60D and 60E. In the calculation process, the calculating section 411 utilizes table information (information describing correlation between specific numerical values) or an arithmetic expression to obtain a concentration measurement value from a concentration detection value and a liquid temperature detection value.

The auxiliary mechanism operating section 412 controls the auxiliary mechanism, such as a pump, based on the concentration measurement value obtained by the calculating section 411, so that the methanol concentration of the methanol solution can be kept at an appropriate value.

The control section 413 causes the storage section 414 to store a concentration measurement value calculated by the calculating section 411, when the power generating operation of the DMFC stack 42 terminates. When a power generating operation of the DMFC stack 42 starts, if there is a difference of a certain amount or greater between a concentration measurement value newly calculated by the calculating section 411 and a concentration measurement value stored in the storage section 414, the control section 413 corrects the concentration measurement value obtained by the calculating section 411 or instructs the auxiliary mechanism operating section 412 to control the auxiliary mechanism based on the corrected concentration measurement value so as to keep the difference smaller than the certain amount. If the difference is not reduced below the certain amount even after correction is performed predetermined times, the control section 413 outputs information indicative of an error, in the form of display information or a sound, in the fuel cell unit body 12 or via the information processing apparatus 18, thereby informing the user of the error.

The storage section 414 stores the concentration measurement value calculated by the calculating section 411 under the control of the control section 413, when the power generating operation by the DMFC stack 42 terminates. The concentration measurement value stored in the storage section 414 is maintained even while the power generation operation of the DMFC stack 42 halts. The control section 413 refers to the value, when the power generating operation of the DMFC stack 42 starts.

The amount of correction applied to the correction processing in the control section 413 is obtained by, for example, the following equation:
Correction Amount (mol/L)=Concentration Measurement Value (mol/L) at End of Power Generation−Concentration Measurement Value (mol/L) at Start of Power Generation.

More specifically, the correction amount corresponds to the difference between a concentration measurement value (mol/L) stored in the storage section 414 at the end of power generation and a concentration measurement value (mol/L) calculated by the calculating section 411 at the start of next power generation. However, if the difference between a concentration measurement value (mol/L) at the end of power generation and a concentration measurement value (mol/L) at the start of next power generation is smaller than a certain amount, correction processing is not performed. For example, if the difference is smaller than 0.2 (mol/L) as shown in FIG. 12, correction processing is not performed; and if the difference is equal to or greater than 0.2 (mol/L), correction processing is performed.

When correction processing is performed using the above-mentioned correction amount, a corrected concentration measurement value is obtained by, for example, the following equation:
Corrected Concentration Measurement Value (mol/L)=Uncorrected Concentration Measurement Value (mol/L)+Correction Amount (mol/L).

The corrected concentration measurement amount (mol/L) thus obtained is used by the auxiliary mechanism operating section 412 to control the auxiliary mechanism.

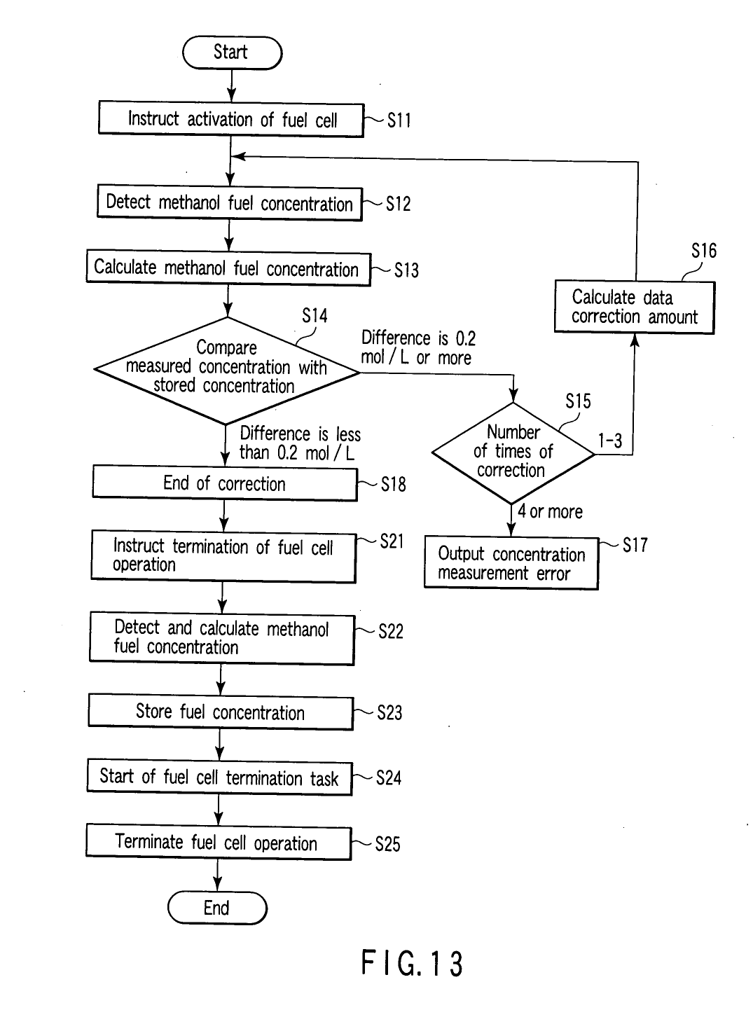

Operations executed in the concentration sensor 60 and the fuel cell control section 41 will be described with reference to FIG. 13.

When the fuel cell control section 41 receives an instruction to start operation (activation) of the DMFC stack 42 (block S11), it acquires a detection value of the methanol concentration in the methanol solution and a detection value of the liquid temperature through the concentration sensor 60 (block S12) and calculates a concentration measurement value using table information or the like (block S13).

The fuel cell control section 41 compares the concentration measurement value calculated in the block S13 with the concentration measurement value stored in the storage section 414 when the operation of the DMFC stack 42 is stopped. Then, the fuel cell control section 41 determines whether there is a difference of a certain amount or more (0.2 (mol/L or more) in this embodiment) between the two values (block S14).

If the fuel cell control section 41 determines that there is a difference of the certain amount or more in the block S14, it determines that correction processing should be performed. The methanol concentration in the methanol solution remaining in the DMFC stack 42 is liable to change (lower) with time under a specific law. In consideration of the change with time, therefore, if there is a difference of the certain amount or more between the concentration measurement values, the fuel cell control section 41 determines to perform correction processing such that the calculated concentration measurement value corresponds to the concentration measurement value at the time when the previous operation is stopped. The fuel cell control section 41 counts up the number of times of correction stored in a predetermined memory area (block S15). If the number of times of correction is one to three, the correction amount is calculated and correction processing is performed using the correction amount (block S16). Then, the process from the blocks S12 to S15 is repeated.

If the number of times of correction is four, appropriate control cannot be executed. In this case, the fuel cell control section 41 outputs information indicative of an error (block S17). Since the concentration measurement value may temporarily have an error due to bubbles in the methanol solution or a sudden temperature change, the above comparison process is performed, for example, up to four times. If there is a difference of the certain amount or more between the concentration measurement values in the fourth comparison, information indicative of an error is output. If an error occurs, the operation may be stopped by, for example, an instruction by the user to terminate the operation of the DMFC stack 42. Alternatively, the operation may automatically be terminated.

If the difference is determined to be smaller than the certain amount in the block S14, correction processing is not performed (block S18) and the ordinary operation is continued.

Thereafter, when the fuel cell control section 41 receives an instruction to terminate (stop) operation of the DMFC stack 42 (block S21), it acquires a detection value of the methanol concentration in the methanol solution and a detection value of the liquid temperature through the concentration sensor 60 and calculates a concentration measurement value using table information or the like (block S22). It causes the storage section 414 to store the calculated concentration measurement value (block S23). The concentration measurement value stored in this block S23 will be used in a comparison process when operation of the DMFC stack 42 is started next (block S14 described above).

Then, the fuel cell control section 41 performs tasks necessary to terminate operation of the DMFC stack 42 (block S24), and terminates the operation (block S25).

As described above, according to the embodiment of the present application, even if the hygroscopic condition of a member constituting the sensor changes or the member is deformed with time in a period from the time when the power generating operation of the fuel cell is stopped to the time when the fuel cell is activated next, and if the propagation distance of an ultrasonic pulse accordingly varies or the concentration measurement value is abnormal at the time of activating the fuel cell, a difference between detected concentration measurements values can be appropriately compensated for by correction processing. As a result, the stability in activating the DMFC stack 42 can be improved.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A fuel cell unit capable of generating power by a fuel cell, the fuel cell unit comprising:
a concentration measuring section to measure a concentration of a fuel solution for use in power generation by the fuel cell;
a storage section to store a first concentration measurement value obtained from the concentration measuring section when power generation by the fuel cell terminates; and
a control section to correct a second concentration measurement value obtained from the concentration measuring section when power generation by the fuel cell starts, if there is a difference of a certain amount or more between the first concentration measurement value stored in the storage section and the second concentration measurement value obtained from the concentration measuring section, to keep the difference under the certain amount.

2. The fuel cell unit according to claim 1, wherein the concentration measuring section comprises a sensor to detect a sonic speed of an ultrasonic pulse passing through the fuel solution and a temperature of the fuel solution.

3. The fuel cell unit according to claim 2, wherein the concentration measuring section comprises a calculating section to calculate the first and second concentration measurement values based on the sonic speed and the temperature detected by the sensor.

4. The fuel cell unit according to claim 1, wherein the control section controls an auxiliary mechanism of the fuel cell unit based on the corrected concentration measurement value.

5. The fuel cell unit according to claim 1, wherein the control section outputs information indicative of an error, when the difference is not reduced under the certain amount after the second concentration measurement value has been corrected a predetermined number of times.

6. A method of correcting a measurement value applied to a fuel cell unit capable of generating power by a fuel cell, the method comprising:
measuring a concentration of a fuel solution for use in power generation by the fuel cell;
storing a first concentration measurement value obtained from the concentration measurement in a storage section when power generation by the fuel cell terminates; and
correcting a second concentration measurement value obtained from the concentration measurement when power generation by the fuel cell starts, if there is a difference of a certain amount or more between the first concentration measurement value stored in the storage section and the second concentration measurement value obtained from the concentration measurement, to keep the difference under the certain amount.

7. The method according to claim 6, wherein the concentration measurement comprises detecting by a sensor a sonic speed of an ultrasonic pulse passing through the fuel solution and a temperature of the fuel solution.

8. The method according to claim 7, wherein the concentration measurement comprises calculating the first and second concentration measurement values based on the sonic speed and the temperature detected by the sensor.

9. The method according to claim 6, further comprising controlling an auxiliary mechanism of the fuel cell unit based on the corrected concentration measurement value.

10. The method according to claim 6, further comprising outputting information indicative of an error, when the difference is not reduced under the certain amount after the second concentration measurement value has been corrected a predetermined number of times.
